(19) United States
(12) Patent Application Publication
(10) Pub. No.: US 2025/0383396 A1
(43) Pub. Date: Dec. 18, 2025

(54) SYSTEM AND METHOD FOR IDENTIFYING POWER COUPLING EFFECTS

(71) Applicant: Microsemi SoC Corp., Chandler, AZ (US)

(72) Inventors: Deepali Gupta, Hyderabad (IN); Rajashekhar Ninganure, Hyderabad (IN)

(73) Assignee: Microsemi SoC Corp., Chandler, AZ (US)

(21) Appl. No.: 18/821,472

(22) Filed: Aug. 30, 2024

(30) Foreign Application Priority Data
Jun. 13, 2024 (IN) 202441045909

(51) Int. Cl. G01R 31/28

(52) U.S. Cl. CPC G01R 31/28

(57) ABSTRACT

Systems for identifying power coupling effects that include a circuit, at least one processor, and a memory. The circuit may include a power delivery network (PDN) and a plurality of circuit blocks. The memory may store instructions that, when executed by the at least one processor, cause the at least one processor to perform the following operations: extract power structure parameters of the circuit; generate, based on the parameters, a PDN model, said PDN model including the PDN and the plurality of circuit blocks; test, using the PDN model, the plurality of circuit blocks; and identify, based on the testing, a power coupling effect within the PDN.

### CROSS-REFERENCE TO RELATED APPLICATIONS

The current patent application claims the benefit under 35 U.S.C. § 119(a) of the priority date of Indian Provisional Application No. 202441045909 titled “SYSTEM AND METHOD FOR IDENTIFYING POWER COUPLING EFFECTS”; and filed Jun. 13, 2024. The Provisional Application is hereby incorporated by reference, in its entirety, into the current patent application.

### TECHNICAL FIELD

Various examples of the present disclosure relate to systems and methods for identifying power coupling effects within a power delivery network (PDN) of a circuit.

### BACKGROUND

Power delivery networks (PDNs) in silicon devices, such as integrated circuits (ICs), may be susceptible to voltage ripple, or noise, which may cause functional issues and performance degradation when present during IC operation. Power coupling effects may be introduced by die parasitics, such as a parasitic capacitance or a parasitic inductance, without limitation, caused by electrical components included within or connected to the PDN. Additionally, a simulation data file for simulating operation of a circuit having a PDN and a plurality of circuit blocks may be too large to simulate in a timely manner.

This background discussion is intended to provide information related to the present disclosure which is not necessarily prior art.

### SUMMARY OF THE INVENTION

According to various examples of the present disclosure, non-transitory computer readable media may be provided. The non-transitory computer readable media may include instructions stored thereon that, when executed by at least one processor, cause the at least one processor to perform the following operations: extract power structure parameters of a circuit to be tested, said circuit including a power delivery network (PDN) and a plurality of circuit blocks; generate, based on the power structure parameters, a PDN model of the PDN and the plurality of circuit blocks; test, using the PDN model, the plurality of circuit blocks; and identify, based on the testing, a power coupling effect within the PDN.

According to various examples of the present disclosure, a system is provided. The system includes a circuit, at least one processor, and a memory. The circuit may include a power delivery network (PDN) and a plurality of circuit blocks. The memory may store instructions that, when executed by the at least one processor, cause the at least one processor to perform the following operations: extract power structure parameters of the circuit; generate, based on the parameters, a PDN model, said PDN model including the PDN and the plurality of circuit blocks; test, using the PDN model, the plurality of circuit blocks; and identify, based on the testing, a power coupling effect within the PDN.

According to various examples of the present disclosure, a computer implemented method is provided. Power structure parameters of a circuit may be extracted. The circuit may include a power delivery network (PDN) and a plurality of circuit blocks. A PDN model of the PDN and the plurality of circuit blocks may be generated based on the power structure parameters. The plurality of circuit blocks may be tested using the PDN model. A power coupling effect within the PDN may be identified based on the testing.

### BRIEF DESCRIPTION OF THE DRAWINGS

FIG. 1 illustrates an example system for identifying power coupling effects;

FIG. 2 illustrates an example circuit to be tested by the system of FIG. 1;

FIG. 3 illustrates an example power delivery network (PDN) model of the circuit of FIG. 2;

FIG. 4 illustrates an example computing device for testing the circuit of FIG. 2; and

FIG. 5 illustrates an example method for testing the circuit of FIG. 2.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Various examples of the present disclosure relate to systems and methods for identifying power coupling effects within a power delivery network (PDN) of a circuit. The circuit may include the PDN and a plurality of circuit blocks. The PDN may include a plurality of power rails, at least one ground rail, and a plurality of die bumps. In various examples of the present disclosure, a PDN model may be generated for the circuit. The PDN model may be tested. Power coupling effects within the PDN may be identified based on the testing. In various examples, a power coupling effect may refer to a parasitic capacitance or impedance, or other unwanted noise, that may form between components of the PDN. For example, a parasitic capacitance may form between a first power rail and a ground power rail of the PDN when one or more circuit blocks are activated.

In various examples, a computing device may include a circuit simulation application for identifying power coupling effects in the PDN. The circuit simulation application may extract power structure parameters of the PDN. The power structure parameters may include information about the components of the PDN, such as materials used, dimensions, spacing, conductivity, operating conditions, terminals, conductive traces, and electrical connections, without limitation. The circuit simulation application may generate a PDN model from the extracted power structure parameters. The PDN model may include the PDN and the plurality of circuit blocks. In various examples, the circuit simulation application may represent the PDN as a resistor-inductor-capacitor (RLC) circuit model. The PDN model may include the RLC circuit model and the plurality of circuit blocks.

In various examples, the circuit simulation application may execute a testing process on the PDN model. For example, activation, input and output generation and recording described herein may be with reference to the PDN model. The circuit simulation application may activate a first circuit block of the plurality of circuit blocks and record a first output of the first circuit block. The first output of the first circuit block may be an expected output of the first circuit block. The expected output may correspond to an output that is unaffected by noise in the circuit. The circuit simulation application may activate the first circuit block and a second circuit block of the plurality of circuit blocks. The circuit simulation application may record a second output of the first circuit block. The circuit simulation application may compare the first output and the second output. The circuit simulation application may identify a power coupling effect within the PDN if the second output is different than the first output. In other words, if activation of the second circuit block causes a change to the output of the first circuit block, a power coupling effect within the PDN is identified. The circuit simulation application may repeat the testing process for each of the plurality of circuit blocks, in various combinations with others of the plurality of circuit blocks, to identify power coupling effects within the PDN.

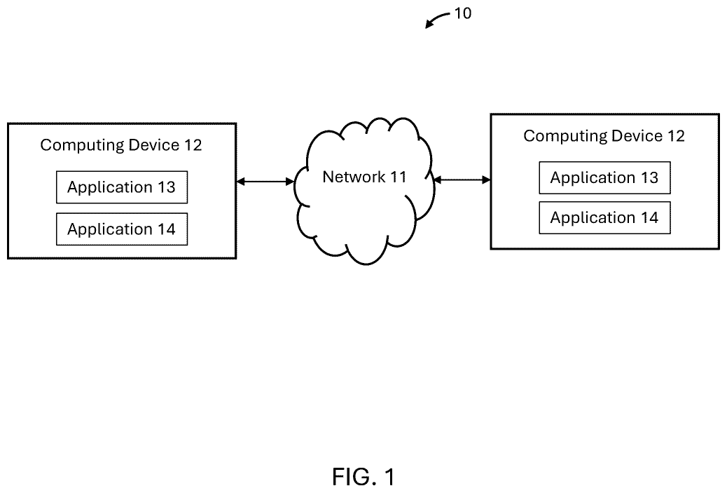

FIG. 1 illustrates an environmental view of an example system 10 for identifying power coupling effects in a circuit. The system may include a communications network 11 and computing devices 12. At least one of the computing devices 12 may include a circuit simulation application 13 for identifying power coupling effects in a circuit. The application 13 of a computing device 12 may comprise one or both of the circuit simulation application and the PDN model, and an data provision application 14 of a computing device 12 may provide data regarding the circuit to be tested, such as extracted power structure parameters, to the other of the computing devices 12. The computing devices 12 may store information for circuits to be tested. The computing devices 12 may exchange the information over the communication network 11.

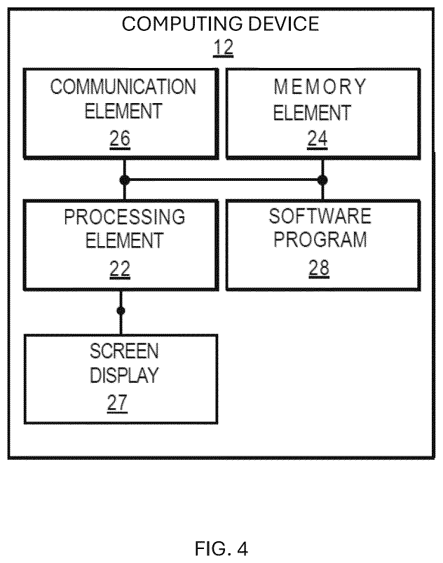

FIG. 4 illustrates an example computing device 12 configured to execute the circuit simulation application 13 of FIG. 1. The computing device 12 may include one or more tablet computers, laptop computers, desktop computers, workstation computers, smart phones, smart watches, and the like. In one or more examples, the computing device 12 may comprise server(s).

The computing device 12 may include a processing element 22, a memory element 24, and circuitry capable of wired and/or wireless communication with the communication network 11, including, for example, a transceiver or communication element 26. The communication element may include a JTAG interface, an ethernet interface, or an SPI interface, without limitation. The computing device 12 may additionally include a screen display 27, which may comprise a user interface of the computing device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen. In various examples, a graphical user interface of an application-such as software program 28, discussed below-for executing the simulation(s) and/or model(s) discussed herein may be rendered on the display 27.

Further, the computing device 12 may include a software application or program 28 configured with instructions for performing and/or enabling performance of at least some of the steps set forth herein. In various examples, the software program 28 comprises instructions respectively stored on computer-readable media of a memory element 24. The software application 28 may correspond to one or both of the circuit simulation application 13 and the data provision application 14, described in reference to FIG. 1.

The communication element 26 generally allows communication between the computing device 12 and the communication network 11. The communication element 26 may include one or more signal or data transmitting and receiving circuits, such as antennas, amplifiers, filters, mixers, oscillators, Ethernet interfaces, digital signal processors (DSPs), and the like. The communication element 26 may establish communication wirelessly by utilizing radio frequency (RF) signals and data that complies with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication element 26 may utilize communication standards such as ANT, ANT+, Bluetooth™ low energy (BLE), the industrial, scientific, and medical (ISM) band at 2.4 gigahertz (GHz), or the like. The communication element 26 may establish communication through connectors or couplers that receive metal conductor wires or cables, like Cat 6 or coax cable, which are compatible with networking technologies such as Ethernet. In various examples, the communication element 26 may also couple with optical fiber cables and may include one or more JTAG interfaces, Ethernet interfaces, or SPI interfaces, without limitation. The communication element 26 may be in communication with the processing element 22 and the memory element 24.

The memory element 24 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 24 may be embedded in, or packaged in the same package as, the processing element 22. The memory element 24 may include, or may constitute, a “computer-readable medium.” The memory elements 24 may store the instructions, code, code segments, software, firmware, programs, applications, apps, services, daemons, or the like that are executed by the processing element 22. In an embodiment, the memory element 24 respectively store the software applications/program 28. The memory element 24 may also store settings, data, documents, sound files, photographs, movies, images, databases, and the like.

The processing element 22 may include electronic hardware components such as processors. The processing element 22 may include digital processing unit(s). The processing element 22 may include one or more microprocessors (single-core and multi-core), microcontrollers, digital signal processors (DSPs), field-programmable gate arrays (FPGAs), analog, or digital application-specific integrated circuits (ASICs), or the like, or combinations thereof, without limitation. The processing element 22 may generally execute, process, or run instructions, code, code segments, software, firmware, programs, applications, apps, processes, services, daemons, or the like. For instance, the processing element 22 may respectively execute the software applications/program 28. The processing element 22 may also include hardware components such as finite-state machines, sequential and combinational logic, and other electronic circuits that can perform the functions necessary for the operation of embodiments of the current disclosure. The processing element 22 may be in communication with the other electronic components through serial or parallel links that include universal busses, address busses, data busses, control lines, and the like.

Referring back to FIG. 1, the communication network 11 generally allows communication between the computing devices 12 and other computing devices. The communication network 11 may include the Internet, Ethernet networks, cellular communication networks, local area networks, metro area networks, wide area networks, cloud networks, plain old telephone service (POTS) networks, and the like, or combinations thereof. The communication network 11 may be wired, wireless, or combinations thereof and may include components such as modems, gateways, switches, routers, hubs, access points, repeaters, towers, and the like. The computing device 12 may, for example, connect to the communication network 11 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

In various examples, the circuit simulation application 13 and the data provision application 14 may include instructions that are stored on the memory element 24 of one or more of the computing devices 12. The instructions may be executed by the processing element 22 of the computing device 12. The circuit simulation application 13 may include instructions for testing a circuit to identify power coupling effects. The circuit simulation application 13 may retrieve information for a circuit to be tested from the data provision application 14. For example, the computing device 12 running the circuit simulation application 13 may retrieve such information from the other computing device 12 running the data provision application 14. The circuit simulation application 13 may extract power structure parameters of the circuit from the retrieved information. In various examples, the circuit may include a power delivery network (PDN) and a plurality of circuit blocks. The power structure parameters may include information about the components of the PDN, such as materials used, dimensions, spacing, conductivity, operating conditions, terminals, conductive traces, and electrical connections, without limitation. In various examples, the power structure parameters may be automatically extracted from the retrieved information for the circuit. The information may be stored in and retrieved from the memory element 24 or retrieved from another computing device, such as another computing device 12, over the communication network 11. In another example, the power structure parameters may be manually extracted by a user of the computing device 12. In various examples, the power structure parameters may be at least partially extracted automatically by the circuit simulation application 13 and partially extracted manually by the user.

In various examples, the circuit simulation application 13 may generate a PDN model for the PDN. The PDN model may represent the PDN with reduced complexity for simulation purposes. In various examples, the circuit simulation application 13 may build the PDN model by encoding the power structure parameters to reduce a dimensionality of one or more of the parameters. In various examples, the circuit simulation application 13 may build the PDN model by filtering out parameters that may not affect simulated operation of the PDN. In various examples, the PDN model may be a resistor-inductor-capacitor (RLC) circuit model. It would be appreciated by one of ordinary skill in the art that other circuit models, such as a resistor-capacitor (RC), inductor-capacitor (LC), or combinations thereof, without limitation, may be generated to represent the PDN without departing from the scope of the present disclosure. Representing the PDN as a circuit model, such as an RLC circuit model, may reduce computational complexity, power consumption, and reduce an amount of time utilized for testing with respect to simulating operation of the PDN.

In various examples, the PDN model may include the plurality of circuit blocks of the circuit. In various examples, the plurality of circuit blocks may be ASIC blocks or FPGA circuit blocks, without limitation. The plurality of circuit blocks may be operable to perform respective functions. The PDN model may further include a control circuit for activating the plurality of circuit blocks. The control circuit or controller may be electrically connected to the plurality of circuit blocks and may provide enable signal(s) to respective ones of the plurality of circuit blocks. The enable signal(s) may activate the respective ones of the plurality of circuit blocks. The circuit blocks may be electrically coupled to the PDN and may receive electrical power from the PDN. The plurality of circuit blocks may generate respective output signals when activated.

In various examples, the circuit simulation application 13 may test the circuit by simulating operation of the PDN model. The circuit simulation application 13 may instruct the controller to activate a first circuit block of the plurality of circuit blocks. After the first circuit block is activated, the circuit simulation application 13 may record a first output of the first circuit block. The circuit simulation application 13 may subsequently activate the first circuit block and a second circuit block of the plurality of circuit blocks. After activating the first and second circuit blocks, the circuit simulation application 13 may record a second output from the first circuit block. After recording the first and second outputs from the first circuit block, the circuit simulation application 13 may compare the first and second outputs. The circuit simulation application 13 may determine that the first output is different than the second output. When the circuit simulation application 13 determines that the first output is different than the second output, a power coupling effect within the PDN may be identified. The circuit simulation application 13 may determine that the first output is the same as the second output. When the circuit simulation application 13 determines that the first output is the same than the second output, a power coupling effect is not identified. In various examples, the circuit simulation application may activate the first circuit block and a third circuit block, record a third output from the first circuit block, and compare the first output and the third output. If the first output is different than the third output, a power coupling effect is identified to be present in the PDN. In this manner, the circuit simulation application 13 may test all possible combinations of active circuit blocks to identify power coupling effects within the PDN caused by activation of one or more of the circuit blocks.

In various examples, the circuit simulation application 13 may identify power coupling effects caused by activation of one or more of the circuit blocks, as described above. The power coupling effects may be caused by parasitic coupling between components of the PDN. The PDN may include a plurality of power rails and a ground rail. The plurality of power rails may supply power to respective ones of the plurality of circuit blocks. The ground rail may provide electrical grounding for the plurality of circuit blocks. Power coupling effects may occur when a first power rail becomes parasitically coupled with a second power rail, the ground rail, one or more die bumps included in the PDN, or other circuitry components present within the PDN. In various examples, activation of one or more of the circuit blocks may cause such power coupling effects to occur. Identification of power coupling effects by the circuit simulation application 13 may enable power structures of various circuits to be tested before manufacturing, which may reduce manufacturing costs and improve manufacturing efficiency because a physical prototype of a circuit is not required to test for power coupling effects within the circuit.

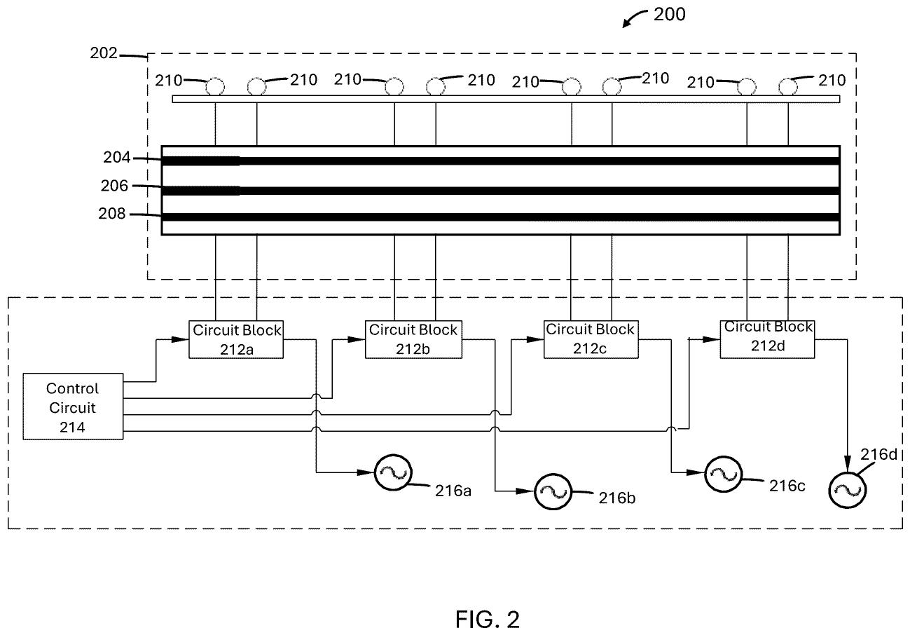

FIG. 2 illustrates a circuit 200 in accordance with various examples of the present disclosure. The circuit 200 may include a power delivery network (PDN) 202, a plurality of circuit blocks 212a, 212b, 212c, 212d, and a control circuit 214. The PDN may include a first power rail 204, a second power rail 206, a ground rail 208, and die bumps 210. The first and second power rails 204, 206 may supply electrical power from one or more external power supplies (not shown) to respective ones of the circuit blocks 212a, 212b, 212c, 212d. The control circuit 214 may control activation and deactivation of the circuit blocks 212a, 212b, 212c, 212d. Each of the circuit blocks 212a, 212b, 212c, 212d may produce respective output signals via output terminals 216a, 216b, 216c, 216d.

In various examples, the control circuit 214 may generate enable signals to active respective ones of the plurality of circuit blocks 212a, 212b, 212c, 212d. Activation of one or more of the plurality of circuit blocks 212a, 212b, 212c, 212d may cause a power coupling effect in the circuit 200. The power coupling effect may be a parasitic coupling of two or more components of the PDN 202. The power coupling effect may occur between any combination of the first and second power rails 204, 206, the ground rail 208, and the die bumps 210.

In various examples, a circuit simulation application, such as the circuit simulation application 13 described with reference to FIG. 1, may simulate operation of the circuit 200. The circuit simulation application may instruct the control circuit 214 to generate an enable signal and provide the enable signal to the circuit block 212a. The first circuit block 212a may generate a first output signal via the first output terminal 216a. The circuit simulation application may then record the first output of the first circuit block 212a. The first output may correspond to an expected output of the first circuit block 212a. The expected output may correspond to an output that is unaffected by noise in the circuit. The circuit simulation application may then cause the controller 214 to activate the first circuit block 212a and the second circuit block 212b. The first circuit block 212a and the second circuit block 212b may be activated simultaneously or within an overlapping time period. The first circuit block 212a may generate a second output via the first output terminal 216a. The second output may correspond to an output of the first circuit block 212a when both the first circuit block 212a and the second circuit block 212b are active. The circuit simulation application may compare the first output with the second output. A power coupling effect within the PDN 202 may be identified if the first output is different than the second output.

Various combinations of the circuit blocks 212a, 212b, 212c, 212d may be activated in this manner by the controller 214 at different times. If an output from any one of the circuit blocks 212a, 212b, 212c, 212d changes due to activation of another one of the circuit blocks 212a, 212b, 212c, 212d, power coupling effects may be identified within the PDN 202. Although the circuit 200 is shown to have four (4) circuit blocks 212a, 212b, 212c, 212d, it would be appreciated by one of ordinary skill in the art that the circuit 200 may include more or less circuit blocks without departing from the scope of the present disclosure.

In various examples, the circuit 200 may not be simulated as a whole to identify power coupling effects due to a simulation data file size being too large. The circuit 200 may include a large number of circuit components to be tested which may cause the simulation data file to include too much data for the circuit 200 to be tested in a timely manner. In various examples, the simulation data file of the circuit 200 may include too much data for the circuit 200 to be tested at all. The circuit simulation application may extract power structure parameters of the PDN 202. The power structure parameters may include information about circuitry components of the PDN of the circuit 200, such as materials used, dimensions, spacing, conductivity, operating conditions, terminals, conductive traces, and electrical connections, without limitation. The extracted power structure parameters may be used to generate a PDN model having reduced complexity. In various examples, the circuit simulation application 13 may build the PDN model by encoding the power structure parameters to reduce a dimensionality of one or more of the parameters. In various examples, the circuit simulation application 13 may build the PDN model by filtering out parameters that may not affect simulated operation of the PDN. Accordingly, operation of the PDN model may be simulated to identify power coupling effects within the PDN 202. The simulation of the PDN model may have reduced computational complexity, reduced simulation time, and reduced power consumption compared to simulating the circuit 200 as a whole.

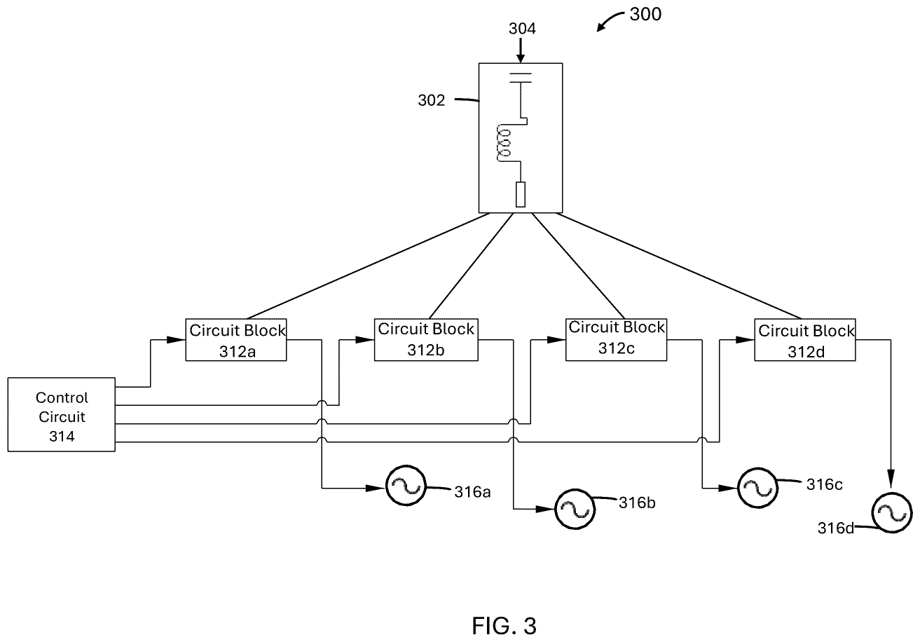

FIG. 3 illustrates a power delivery network (PDN) model 300. The PDN model 300 may represent a circuit to be tested. In various examples, the circuit to be tested may correspond to the circuit 200 shown in FIG. 2. The PDN model 300 may include a PDN 302, an input power supply 304, a plurality of circuit blocks 312a, 312b, 312c, 312d, and a control circuit 314. In various examples, the PDN 302 may be a circuit model, such as a resistor-inductor-capacitor (RLC) circuit model. It would be appreciated by one of ordinary skill in the art that other circuit models, such as a resistor-capacitor (RC), inductor-capacitor (LC), or combinations thereof, without limitation, may be generated to represent the PDN without departing from the scope of the present disclosure. Representing the PDN as a circuit model, such as an RLC circuit model, may reduce computational complexity, power consumption, and reduce an amount of time utilized for testing with respect to simulating operation of the PDN. The PDN 302 may receive electrical power from the input power supply 304. The input power supply 304 may represent one or more external power supplies electrically connected to the voltage rails 204, 206 described in FIG. 2. The input power supply 304 may provide a supply voltage to the PDN 302. The PDN 302 may, in turn, provide the supply voltage to the circuit blocks 312a, 312b, 312c, 312d.

The PDN 302 may represent power structure parameters extracted from the PDN 202 of the circuit 200. The power structure parameters may include information about circuitry components of the PDN of the circuit 200, such as materials used, dimensions, spacing, conductivity, operating conditions, terminals, conductive traces, and electrical connections, without limitation. The circuitry components of the PDN 302 may include a plurality of power rails, at least one ground rail, and a plurality of die bumps, without limitation.

The plurality of circuit blocks 312a, 312b, 312c, 312d, may be electrically connected to the control circuit 314 and the PDN 302. The control circuit 314 may control activation and deactivation of the plurality of circuit blocks 312a, 312b, 312c, 312d. The PDN 302 may supply electrical power to the plurality of circuit blocks 312a, 312b, 312c, 312d.

In various examples, a circuit simulation application, such as the circuit simulation application 13 described with reference to FIG. 1, may simulate operation of the PDN model 300. The circuit simulation application may instruct the control circuit 314 to generate an enable signal and provide the enable signal to the first circuit block 312a. The first circuit block 312a may generate a first output signal via the first output terminal 316a in response to being activated. The circuit simulation application may then record the first output of the first circuit block 312a. The first output may correspond to an expected output of the first circuit block 312a. The expected output may correspond to an output that is unaffected by noise in the circuit. The circuit simulation application may then cause the controller 314 to activate the first circuit block 312a and the second circuit block 312b. The first and second circuit blocks 312a and 312b may be activated simultaneously or within a same time period. The first circuit block 312a may generate a second output via the first output terminal 316a. The second output may correspond to an output of the first circuit block 312a when both the first and second circuit blocks 312a and 312b are active. The circuit simulation application may compare the first output with the second output. A power coupling effect within the PDN 302 may be identified if the first output is different than the second output.

Various combinations of the circuit blocks 312a, 312b, 312c, 312d may be activated by the controller 314 at different times. If an output from any one of the circuit blocks 312a, 312b, 312c, 312d changes due to activation of another one of the circuit blocks 312a, 312b, 312c, 312d, power coupling effects may be identified within the PDN 202. Although the PDN model 302 is shown to have four (4) circuit blocks 312a, 312b, 312c, 312d, it would be appreciated by one of ordinary skill in the art that the PDN model 302 may include more or less circuit blocks without departing from the scope of the present disclosure. The simulation of the PDN model 302 may have reduced computational complexity, reduced simulation time, and reduced power consumption compared to simulating a circuit, such as the circuit 200, as a whole.

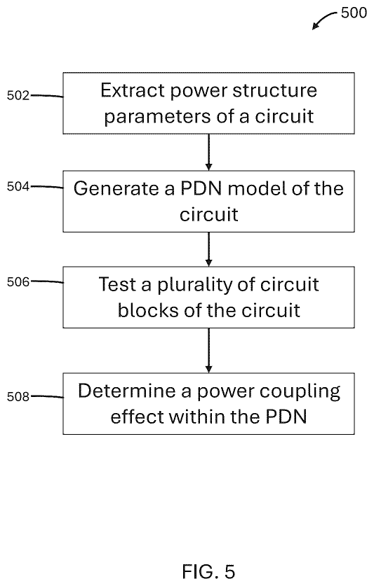

FIG. 5 illustrates an example computer-implemented method 500 for testing a circuit, such as the circuit 200 described with reference to FIG. 2. In various examples, the method 500 may be performed by a computing device, such as one of the computing devices 12 described with reference to FIG. 1. The computing device may include a memory and at least one processor. The memory may store a circuit simulation application, such as the circuit simulation application 13 described with reference to FIG. 1. The circuit simulation application may be executed by the at least one processor carry out the method 500.

At operation 502, power structure parameters of a circuit may be extracted. In various examples, the circuit may be the circuit 200 described with reference to FIG. 2. The circuit may include a power delivery network (PDN) and a plurality of circuit blocks. The PDN may include a plurality of electrical components. The electrical components may include a plurality of power rails, at least one ground rail, and a plurality of die bumps, without limitation. The power structure parameters may include information about the electrical components of the PDN, such as materials used, dimensions, spacing, conductivity, operating conditions, terminals, conductive traces, and electrical connections, without limitation. The power structure parameters may be extracted automatically by the circuit simulation application, manually by a user operator of the circuit simulation application, or both automatically and manually, without limitation.

At operation 504, a PDN model of the circuit may be generated. The PDN model may include a representation of the PDN and the plurality of circuit blocks. The representation of the PDN may include a circuit model. In various examples, the circuit model may be a resistor-inductor-capacitor (RLC) circuit model, as described with reference to FIG. 3. It would be appreciated by one of ordinary skill in the art that other circuit models, such as a resistor-capacitor (RC), inductor-capacitor (LC), or combinations thereof, without limitation, may be generated to represent the PDN without departing from the scope of the present disclosure. Representing the PDN as a circuit model, such as an RLC circuit model, may reduce computational complexity, power consumption, and reduce an amount of time utilized for testing with respect to simulating operation of the PDN.

The PDN model may further include a controller electrically connected to the plurality of circuit blocks. The controller may generate enable signals to activate respective ones of the plurality of circuit blocks. The plurality of circuit blocks may be electrically connected to the PDN. The plurality of circuit blocks may receive electrical power from the PDN.

At operation 506, the plurality of circuit blocks may be tested. The controller may activate a first circuit block of the plurality of circuit blocks. The first circuit block may produce an output signal in response to being activated. A value of the first output signal may be recorded. The first output signal may correspond to an expected output of the first circuit block. The expected output may correspond to an output that is unaffected by noise in the circuit. The controller may subsequently activate the first circuit block and a second circuit block of the plurality of circuit blocks. The first and second circuit blocks may be activated simultaneously or within a same time period. The first circuit block may produce a second output in response to being activated in connection with the second circuit block. The second output may correspond to an output of the first circuit block when both the first and second circuit blocks are active. A second value of the second output signal may be recorded. The circuit simulation application may cause the controller to activate various combinations of the circuit blocks. Each circuit block may be activated at a respective time while all other circuit blocks are deactivated to record expected output signals from each of the circuit blocks. Each circuit block may be activated with different combinations of circuit blocks to record subsequent output signals. In this manner, the circuit simulation application may test all possible combinations of active circuit blocks, or a subset thereof.

At operation 508, a power coupling effect within the PDN may be identified. The circuit simulation application may compare the first output signal and the second output signal. The first output signal may be determined to be different than the second output signal. The circuit simulation application may identify a power coupling effect within the PDN when the first output signal is determined to be different than the second output signal. In this manner, the circuit simulation application may compare expected output signals from each of the circuit blocks with output signals recorded when multiple circuits are activated under various sequence parameters. The expected output signals may correspond to output signals that are unaffected by noise in the circuit. If any output signal has a different value than its corresponding expected output signal, a power coupling effect within the PDN may be identified. If each recorded output signals is the same as its corresponding expected output signal, no power coupling effects within the PDN may be identified.

According to various examples of the present disclosure, non-transitory computer readable media may be provided. The non-transitory computer readable media may include instructions stored thereon that, when executed by at least one processor, cause the at least one processor to perform the following operations: extract power structure parameters of a circuit to be tested, said circuit including a power delivery network (PDN) and a plurality of circuit blocks; generate, based on the power structure parameters, a PDN model of the PDN and the plurality of circuit blocks; test, using the PDN model, the plurality of circuit blocks; and identify, based on the testing, a power coupling effect within the PDN.

In combination with any of the above examples, generating the PDN model may include generating a resistor-inductor-capacitor (RLC) circuit model of the PDN. The PDN model may include the RLC circuit model and the plurality of circuit blocks.

In combination with any of the above examples, the power coupling effect may be identified at least in part caused by activation of one or more of the plurality of circuit blocks.

In combination with any of the above examples, the testing may include activating a first circuit block of the plurality of circuit blocks and recording a first output of the first circuit block.

In combination with any of the above examples, the testing may include activating the first circuit block of the plurality of circuit blocks, activating a second circuit block of the plurality of circuit blocks, and measuring a second output of the first circuit block.

In combination with any of the above examples, identifying the power coupling effect may include comparing the first output and the second output and determining that the first output is different than the second output.

According to various examples of the present disclosure, a system is provided. The system includes a circuit, at least one processor, and a memory. The circuit may include a power delivery network (PDN) and a plurality of circuit blocks. The memory may store instructions that, when executed by the at least one processor, cause the at least one processor to perform the following operations: extract power structure parameters of the circuit; generate, based on the parameters, a PDN model, said PDN model including the PDN and the plurality of circuit blocks; test, using the PDN model, the plurality of circuit blocks; and identify, based on the testing, a power coupling effect within the PDN.

In combination with any of the above examples, generating the PDN model may include generating a resistor-inductor-capacitor (RLC) circuit model of the PDN. The PDN model may include the RLC circuit model and the plurality of circuit blocks.

In combination with any of the above examples, the power coupling effect may be identified at least in part caused by activation of one or more of the plurality of circuit blocks.

In combination with any of the above examples, the testing may include activating a first circuit block of the plurality of circuit blocks and measuring a first output of the first circuit block.

In combination with any of the above examples, the testing may include activating the first circuit block of the plurality of circuit blocks, activating a second circuit block of the plurality of circuit blocks, and measuring a second output of the first circuit block.

In combination with any of the above examples, identifying the power coupling effect may include comparing the first output and the second output and determining that the first output is different than the second output.

According to various examples of the present disclosure, a computer implemented method is provided. Power structure parameters of a circuit may be extracted. The circuit may include a power delivery network (PDN) and a plurality of circuit blocks. A PDN model of the PDN and the plurality of circuit blocks may be generated based on the power structure parameters. The plurality of circuit blocks may be tested using the PDN model. A power coupling effect within the PDN may be identified based on the testing.

In combination with any of the above examples, generating the PDN model may include generating a resistor-inductor-capacitor (RLC) circuit model of the PDN. The PDN model may include the RLC circuit model and the plurality of circuit blocks.

In combination with any of the above examples, the power coupling effect may be identified at least in part caused by activation of one or more of the plurality of circuit blocks.

In combination with any of the above examples, the testing may include activating a first circuit block of the plurality of circuit blocks and measuring a first output of the first circuit block.

In combination with any of the above examples, the testing may include activating the first circuit block of the plurality of circuit blocks, activating a second circuit block of the plurality of circuit blocks, and measuring a second output of the first circuit block.

In combination with any of the above examples, identifying the power coupling effect may include comparing the first output and the second output and determining that the first output is different than the second output.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. Non-transitory computer readable media storing instructions, that when executed by at least one processor, cause the at least one processor to:
extract power structure parameters of a circuit to be tested, said circuit including a power delivery network (PDN) and a plurality of circuit blocks;
generate, based on the power structure parameters, a PDN model of the PDN and the plurality of circuit blocks;
test, using the PDN model, the plurality of circuit blocks; and
identify, based on the testing, a power coupling effect within the PDN.

2. The non-transitory computer readable media of claim 1, wherein generating the PDN model includes generating a resistor-inductor-capacitor (RLC) circuit model of the PDN, said PDN model including the RLC circuit model and the plurality of circuit blocks.

3. The non-transitory computer readable media of claim 1, wherein the power coupling effect is at least in part caused by activation of one or more of the plurality of circuit blocks.

4. The non-transitory computer readable media of claim 1, wherein the testing includes activating a first circuit block of the plurality of circuit blocks and measuring a first output of the first circuit block.

5. The non-transitory computer readable media of claim 4, wherein the testing includes activating the first circuit block of the plurality of circuit blocks, activating a second circuit block of the plurality of circuit blocks, and measuring a second output of the first circuit block.

6. The non-transitory computer readable media of claim 5, wherein identifying the power coupling effect includes comparing the first output and the second output and determining that the first output is different than the second output.

7. A system comprising:
a circuit including a power delivery network (PDN) and a plurality of circuit blocks;
at least one processor; and
a memory storing instructions that, when executed by the at least one processor, cause the at least one processor to:
extract power structure parameters of the circuit;
generate, based on the power structure parameters, a PDN model of the PDN and the plurality of circuit blocks;
test, using the PDN model, the plurality of circuit blocks; and
identify, based on the testing, a power coupling effect within the PDN.

8. The system of claim 7, wherein generating the PDN model includes generating a resistor-inductor-capacitor (RLC) circuit model of the PDN, said PDN model including the RLC circuit model.

9. The system of claim 7, wherein the power coupling effect is at least in part caused by activation of one or more of the plurality of circuit blocks.

10. The system of claim 7, wherein the testing includes activating a first circuit block of the plurality of circuit blocks and measuring a first output of the first circuit block.

11. The system of claim 10, wherein the testing includes activating the first circuit block of the plurality of circuit blocks, activating a second circuit block of the plurality of circuit blocks, and measuring a second output of the first circuit block.

12. The system of claim 11, wherein identifying the power coupling effect includes comparing the first output and the second output and determining that the first output is different than the second output.

13. A computer-implemented method comprising:
extracting power structure parameters of a circuit, said circuit including a power delivery network (PDN) and a plurality of circuit blocks;
generating, based on the power structure parameters, a PDN model of the PDN and the plurality of circuit blocks;
testing, using the PDN model, the plurality of circuit blocks; and
identifying, based on the testing, a power coupling effect within the PDN.

14. The computer-implemented method of claim 13, wherein generating the PDN model includes generating a resistor-inductor-capacitor (RLC) circuit model of the PDN, said PDN model including the RLC circuit model.

15. The computer-implemented method of claim 13, wherein the power coupling effect is at least in part caused by activation of one or more of the plurality of circuit blocks.

16. The computer-implemented method of claim 13, wherein the testing includes activating a first circuit block of the plurality of circuit blocks and measuring a first output of the first circuit block.

17. The computer-implemented method of claim 16, wherein the testing includes activating the first circuit block of the plurality of circuit blocks, activating a second circuit block of the plurality of circuit blocks, and measuring a second output of the first circuit block.

18. The computer-implemented method of claim 17, wherein identifying the power coupling effect includes comparing the first output and the second output and determining that the first output is different than the second output.
